(19) United States
(12) Patent Application Publication
(10) Pub. No.: US 2020/0334726 A1
(43) Pub. Date: Oct. 22, 2020

(54) DYNAMICALLY RESPONSIVE PRODUCT DESIGN

(71) Applicant: LOVINGLY, LLC, Fishkill, NY (US)

(72) Inventors: Joseph Vega, Hopewell Junction, NY (US); Kenny Garland, Hopewell Junction, NY (US); Daniela Virginia Marquez, Poughkeepsie, NY (US); Kaitlin Heather Schupp, Kingston, NY (US); Danielle Sarah Gorton, Beacon, NY (US)

(21) Appl. No.: 16/849,477

(22) Filed: Apr. 15, 2020

Related U.S. Application Data
(60) Provisional application No. 62/834,750, filed on Apr. 16, 2019.
(60) Provisional application No. 62/848,634, filed on May 16, 2019.
(60) Provisional application No. 62/968,547, filed on Jan. 31, 2020.

(51) Int. Cl. G06Q 30/06; G06F 3/0488; G06F 3/16

(52) U.S. Cl. CPC G06Q 30/0621; G06F 3/167; G06F 3/0488; G06Q 30/0631

(57) ABSTRACT

A method for generating a gift product involves receiving a plurality of user inputs representative of factors affecting product selection, generating a product name, generating a product description, generating at least one product customization recommendation and generating at least one expenditure recommendation. It can also include communicating each of the product name, the product description, at least one product customization recommendation, and at least one expenditure recommendation to the user as well as receiving a user selection for each of a product customization and an expenditure amount. The method may also include generating a set of instructions for creating the gift product.

### RELATED APPLICATION INFORMATION

This application claims priority to U.S. Provisional Application No. 62/834,750, filed on Apr. 16, 2019, U.S. Provisional Application No. 62/848,634, filed on May 16, 2019, and U.S. Provisional Application No. 62/968,547, filed on Jan. 31, 2020, each of which is incorporated herein by reference in its entirety.

### BACKGROUND

The present invention generally relates to customized gift product designs and product customization, and more particularly to the creation of dynamic floral design products.

When purchasing a gift for someone, an individual usually has some kind of reason or purpose for presenting the gift or an emotion that they are trying to convey to another person. Conventional experiences of digitally procuring gifts don't have any emotional or intentional component and are inevitably riddled with navigating and selecting from among a pre-made and pre-categorized variety of products. Although occasionally items for sale may be organized in categories somewhat representative of an occasion or purpose for which an item may be bought, pre-categorization rarely matches the purchaser's specific purpose and intent of obtaining the gift. Therefore, an experience of digitally purchasing a gift, such as when buying one online, is emotionally, psychologically, and experientially different from that of purchasing a gift from a store in a dramatic way because one is forced to sift through voluminous catalogs and categories of pre-sorted items in an attempt to find something that matches one's intentions and emotional state. Further, these products are often described in rigid terms of specific unchanging constituent parts that do not allow for much flexibility on the part of the fulfiller of the purchase order. This experience is drastically contrasted with being able to interact dynamically with an employee and taking into consideration the intention and emotional state which is sought to be conveyed in order to get a customized gift created or recommended by the employee.

For example, in the floral industry, products are conventionally described in terms of recipes of stem counts (e.g., 3 stems of pink roses, 2 stems of yellow freesia, 2 stems of white Asiatic lilies, etc.). Consequently, in the context of online gift purchases, the names and descriptions used on product pages on websites are directly tied and limited to the specific and static description of the product recipe. Inevitably, consumers end up picking floral products based on the name or description of the product, despite it not actually being the product they need for the emotion they are trying to convey or intend to show with their gift. From the florist perspective, this framework demands that the florist put together an arrangement based on the recipe instead of being able to show off their creativity in floral design and composition.

Occasionally, a potential gift purchaser may come across “designer's choice” arrangements or “custom bouquets” which don't have specific recipes associated with them that allow for florist creativity. However, currently these options are very limited in the industry for the consumer, and the florist and provide nothing in the way of meaningful interaction between purchaser and order fulfiller. On the consumer side, there is no interactive product page experience and the purchaser has no way of communicating his gift purchasing intention. Therefore, even if a dedicated product page exists, it is a static page and does not change based on the reason for the purchase. From the point of view of a prospective florist who is to fill the order, the information received is severely limited and not very useful for assisting in the creation a custom arrangement that is relevant for the customer's reason for purchasing a gift and/or the emotion that the customer is attempting to convey.

Accordingly, for the foregoing reasons, there is a need for a system and method for obtaining a customized gift product design which provides a dynamic and interactive store-like experience that is reflective of a purchaser's intention and emotional state. Likewise, there is a need for a system and method for producing a customized gift product that is flexible enough to allow an order fulfiller to exhibit creativity in matching the product to the purchaser's purpose and emotion(s) intended to be conveyed.

### SUMMARY

Embodiments of the present invention are directed to systems and methods that incorporate the consideration of a prospective product purchaser's emotions and intentions in the creation or suggestion of a gift product, and thereby provide a more natural purchasing experience. The embodiments can further provide instructions to a prospective purchase order fulfiller that are sufficiently informative to appropriately, and specifically, convey the purchasers purpose and intended expression of emotional, yet flexible enough to permit the fulfiller to express their creativity in the creation of the gift product.

In accordance with an embodiment of the present invention, a computer implemented method for generating a gift product, includes receiving, via a product customization system having a user interface communicatively coupled to a networked user device including a processor device, a plurality of user inputs representative of factors affecting product selection. Some embodiments can further include generating a product name; generating a product description; generating a plurality of product customization recommendations; generating a plurality of expenditure recommendations; communicating, via the user device, each of the product name, the product description, the plurality of product customization recommendations, and the plurality of expenditure recommendations to the user. Some embodiments also include receiving a user selection, via the user interface, for each of a color palette, a product customization, and an expenditure amount; and generating, based on the user inputs and user selection, a set of instructions for creating the gift product. In embodiments of the invention, generating each of the product name, the product description, and a plurality of expenditure recommendations can respectively depend at least in part on an input of the plurality of inputs. In some embodiments generating a plurality of product customization recommendations can depend at least in part on an input of the plurality of inputs, and can include generating a plurality of product color palette recommendations and can also include generating a plurality of presentation recommendations. Optionally, embodiments can include displaying the set of instructions on a screen or printing the set of instructions. In some embodiments, the user interface can be a display coupled to a touch sensitive input means. Alternatively, a user interface of an embodiment of the invention can be an audio device configured to emit sounds and receive voice input.

In accordance with an embodiment of the present invention, a non-transitory computer readable medium includes instructions that are executable by a computing device which when executed cause the computing device to prompt a user to perform the method described above

In accordance with an embodiment, the gift product customization system includes a computing device connected to a network, with the computing device having one user interface configured to convey a series of questions or prompts to a user; another user interface configured to receive user input responsive to the series of questions or prompts; and a processor device configured to use the user input to generate a product name, product description, a plurality of product color palette recommendations, a plurality of presentation recommendations, and a plurality of expenditure recommendations. In some embodiments the computing device is configured to communicate each of a product name, product description, a plurality of product color palette recommendations, a plurality of presentation recommendations, and a plurality of expenditure recommendations to a user. Some embodiments also have another computing device connected to the network and configured to communicate a set of instructions for creating the gift product based on user selections among each of the recommendations. In some embodiments, the first user interface is selected from the group consisting of a display coupled to a touch sensitive input means and an audio device configured to emit sounds and receive voice input. The several embodiments of the invention can comprise one or more user interfaces where each can comprise a display coupled to a touch sensitive input means, an audio device configured to emit sounds and receive voice input, or both. In some of the embodiments, one of the computing devices can include a screen configured to display the set of instruction, a printer configured to print the set of instructions, or both.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a flow chart of a method for generating a gift product, in accordance with an embodiment of the present invention;

FIG. 2 is schematic diagram of a system, in accordance with an embodiment of the present invention;

FIGS. 3A-3L are screen shots depicting a plurality of prompts, in accordance with an embodiment of the present invention;

FIGS. 4A-4C depict a customized product page, in accordance with an embodiment of the present invention;

FIG. 5A depicts a florist's super-ticket, in accordance with an embodiment of the present invention;

FIG. 5B shows a set of instructions, in accordance with an embodiment of the present invention; and

FIG. 6 is a schematic diagram of a system, in accordance with an embodiment of the present invention.

### DETAILED DESCRIPTION

In the Summary above and in this Detailed Description, and the claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

Embodiments of the invention relate to systems and methods of providing a dynamic and customized gift product design experience. Employment of the systems and methods described herein provides a user with an experience that mimics obtaining a customized product from a live person that dynamically interacts with the user, and results with a product tailored to the user's circumstances and intended purpose.

In general, embodiments of the invention incorporate an interactive interface through which questions and prompts can be presented to a user. The same interactive interface or an alternative one can also be used to receive input and selections from the user, some of which may be entered by the user in response to the aforementioned questions and prompts. One of the purposes of presenting the user with prompts and questions is to elicit the purpose for which the user is seeking to obtain a gift product, and to identify the emotion or message the user may be attempting to convey to the intended recipient of the gift product.

According to some embodiments of the invention this goal is achieved through dynamic and interactive series of questions and/or prompts which may be interspersed between one another and responded to by the user via a user interface. For example, a variety of interrelated questions may be presented to the user with each subsequent question being, in some embodiments, at least in part dependent on the user's response to a preceding question. Analogously, the user may be presented with a series of prompts for information where each subsequent prompt may be at least in part dependent on the user's input in response to a previous prompt. Thus, through a mutually interrelated series of questions and prompts, various factors affecting the selection and customization of a gift product including who the intended recipient is, what the relationship of the user is to the recipient, what the set of possible reasons for obtaining the gift product are, what the emotional state of the user is, what the direct or indirect message that is intended to be conveyed to the recipient, and what emotion(s) is/are desired to be conveyed to the recipient. In other embodiments, alternatively to or in addition to questions and prompts, information concerning a user's intentions and/or emotions may be obtained view facial recognition, gesture recognition, and/or voice signature analysis. Because a user's non-verbal communication, cues, involuntary reflexes/cues, as well as the tone/timbre of their voice may be indicative of their emotional state with respect to a potential purchase or with respect to a potential recipient, information the information obtained through these alternative means can be used in conjunction with or in lieu of the information obtained through the questions and prompts.

Along with a user's purpose and emotions to convey being ascertained through the embodiments of the present invention, more conventional ordering information such as delivery information including location and timing can be obtained as well. It should be understood that, although the present description may cover a few specific embodiments including particular user interfaces, the embodiments of the invention are intended to incorporate all compatible tactile and audio-visual static and dynamic user interfaces and input means. For example, as described in more detail below, embodiments of the system are envisioned where questions and prompts are presented to a user via a display device while responses and inputs are obtained from a user via a keyboard or a touch screen. Alternatively, other embodiments may involve the set of questions and prompts being presented via an audio device with responses or inputs being received from the user through a microphone.

Having obtained responses and input from the user, embodiments of the present invention then create a customized product based on those inputs and responses that is uniquely tailored to the user's situation and goals. In exemplary embodiments, one or more customized products along with one or more associated costs may be presented to a user on the basis of the previously collected input. These product design options presented to the user may be in the form of various product customization recommendations which can include a variety of configuration options such as product color palette recommendation and product presentation recommendations. In accordance with the several embodiments, the user can then have the opportunity to select from among the presented plurality of customization options to specify the desired configurations, colors, presentations, arrangements, and associated expenditure levels (e.g., costs/prices) for the design of the customized product. It should be understood that the plurality of options and selections presented to the user can be conveyed in a natural language format as one would expect from a conventional interaction with a live salesperson or product designer. Accordingly, a user can, through an embodiment of the invention, place an order for a gift product that includes the desired customizations and specifications indicated or selected by the user.

With the user selections having been made and an order being placed for the purchase of the specified customized product, the embodiments of the invention can synthesize or generate a set of instructions for creating the desired customized gift product that are flexible enough to allow for the expression of creativity on behalf of the creator of the product in fulfilling the order. Notably, in the preferred embodiments of the invention the synthesis and/or generation of the product creation instructions is directly dependent on and are informational derivatives of the individual inputs and selections provided by the user as well as of the interrelationship between them, especially insofar as those inputs, selections, and interrelationship is indicative of a user's intended emotional conveyance. It should be understood that these instructions can convey to the creator of the product and/or the fulfiller of the order information that includes who the intended recipient is, what the relationship of the user is to the recipient, what the set of possible reasons for obtaining the gift product are, what the emotional state of the user is, what the direct or indirect message that is intended to be conveyed to the recipient, and what emotion(s) is/are desired to be conveyed to the recipient. In this manner, the creator or fulfiller can use their experience and creativity to produce a product design that closely coincides with the user's intentions, situation, and emotional goals.

Preferred embodiments of the present invention can be implemented in the floral industry in the context of purchasing and providing a customized floral product. In accordance with the several embodiments, a user can provide natural language inputs and selections instead of having to sift through listings of static descriptions of different flower combinations limited to a specific recipe (e.g., i.e. 3 pink roses, 2 stems yellow freesia, 2 stems white Asiatic lilies, etc.). Similarly, a florist on the receiving end of an embodiment can show off their creativity in creating the floral design, and is not tied to any specific recipe since the instructions that they receive are more flexible than those that are conventionally provided to or followed by florists.

In accordance with an embodiment of the present invention the creation of a customized gift product, such as a custom floral arrangement, can include obtaining and gathering information from a user which is used both in the dynamic interaction with the user via a web-site interface as well as in the provision of the custom product to the intended recipient. Each of a product name, product, description, and recommendations for a floral arrangement design can be derived from user input and selections to make the floral product unique.

Another embodiment includes gathering user input and information which can affect the various options available and customizations that can be selected to be applied to the product. For example, in the context of a floral purchase, a user may be prompted to provide the person by whom the purchase is intended to be received and the reason for the floral purchase. Notably, the reason is not limited to traditional occasions such as birthdays, anniversaries, and the like. Through the various embodiments, upon being prompted to do so, in the course of providing information via a response to a question or through filling out a blank space in a sentence, a user can be presented with pre-populated options that represent traditional occasions, holidays, and common reasons, as well as with novel reasons for the purchase (e.g., “asking if she will be my bridesmaid”). However, since pre-selected or pre-populated reasons may not always coincide with a user's actual situation, free-text input can also be provided by a user and received by embodiments of the invention so that the user can describe their reason in their own words.

It should be understood that the various embodiments hereof are not limited to being employed in the context of the floral industry and are envisioned to be employed in the context of products of other industries as well including, but not limited to, providing customized gift products of sports equipment sets, food and beverage sets, household goods, tools, clothing, equipment sets, and the like. Additionally, customized gift products could be made entirely of digital or virtual media elements such as picture, videos, text, and digital/virtual representations of a user and/or recipient. Accordingly, the questions and prompts and well as the input and selections by the user may differ as may be appropriate for products and intended recipients of those products in the other industries. Where reference is made herein to a florist who is understood to be the fulfiller of an order in the context of a purchase of a floral arrangement, it should be understood that in the context of an order for products of a different industry, the order fulfiller can be an individual with a different title as may be applicable to such industry respectively.

Further, embodiments of the invention include the collection of information regarding the relationship of the intended recipient of the gift product and the user. The input of this information can be realized by free-text input which triggers an auto-suggest feature with pre-populated options for the user to select included a variety of common ways to communicate a particular relationship (e.g., “mama”, “ma”, “mom” can all be understood and interpreted as the recipient being the “mother” of the user). The input is not limited to the pre-populated auto-complete selections and can also include any free text input and the user can describe the relationship in their own words which permits the inclusion of nicknames, pet-names, and unique relationships. If applicable, the name of the intended recipient is also obtained from the user via user input.

Additionally, an important aspect of the embodiments of the invention is obtaining from the user the goal of the gift. The goal of the gift can be understood to be an articulation of the purpose the user has for giving the gift to the intended recipient. This goal can be a certain emotion that the user desires to convey to the recipient, an indication of the user's emotional state that the user intends to communicate to the recipient, a communication of a psychological state, a transmission of a non-verbal message, and the like. Other embodiments can have pre-selected options that the user can select to identify the intended goal they would like to achieve by presenting the product to the recipient. In some embodiments of the invention, the obtention of the goal of the gift or intended emotional goal may be achieved by facial recognition or gesture recognition. Alternatively, a user's voice tone and timbre may be collected and analyzed to determine the gifting goal or emotional goal. Both non-verbal communication recognition and voice signatures can serve as either direct or indirect emotional indicators and can be translated into representations of an emotional or psychological state. The information received or obtained from the user via these methods can be used to affect or alter the resulting product page and/or the generation of the product creation instructions or “recipe”.

After the user has provided the inputs and selections representing factors and motivations affecting the choice and customization of the gift product, some embodiments of the invention synthesize the gathered information to generate and present to the user a product page for the customized product. The product page can display a variety of information regarding the customized product including a product name and a product description as well as customization recommendations and price options. The product name is derived from the combination and synthesis of the recipient name, relationship, and reason for obtaining the gift product that the user provided. It should be understood that for every customized product, a different product name can be dynamically generated and presented based on the user inputs and provided information discussed above. Similarly, a product description is also derived from the user inputs and information provided by the user with the various combinations of gifting reasons, relationships, and gifting goals dynamically resulting in different product descriptions. Customization recommendations in embodiments of the invention utilized in the context of a purchase of a floral arrangement can include color palette recommendations (e.g., a “Pastel Mix”) as well as flower design presentation recommendations (e.g., “hand-wrapped”). The color palette recommendations and design presentation recommendations can be pre-selected for the user based on the inputs and information provided, and can be either confirmed or altered by the user by selecting from a variety of alternative options for the color palette and the design presentation of the floral arrangement. Having made or confirmed the selections concerning the desired customization of the product, as well as selecting from among a set of florist and delivery options, the user can select a desired expenditure amount and place an order for the customized gift product.

It should be understood that in the context of products of a different industry, the product names, descriptions, and customization recommendations would vary accordingly. For example, if the customized gift product is for a set of clothes or equipment, a customization recommendation can include recommendations for configurations of products pertaining to that category (e.g., “red shorts and blue t-shirt” or “skirt, large hat, and white blouse” for clothes, “mitt, bat, and baseball” for baseball, etc.). Analogously, the presentation recommendations can include packaging/boxing suggestions, matching items that are used together, color-coordinating or arranging items according to a predetermined or selected logical order (e.g., by size, shape, order of use when engaged in a particular task). For example, in the context of creating a customized gift product pertaining to a set of work tools, customization recommendations may include presentation recommendations of having them arranged in size order while in the context of creating a customized gift product pertaining to a set of clothes, presentation recommendation may include having clothing pieces be color coordinated or arranged by matching styles. Accordingly, in each context, the user can either confirm or select from a set of order fulfillers, a set of recommendations offered, delivery options, and expenditure suggestions.

The input and selections obtained from the user are combined to generate a unique recipe instructing an order fulfiller (e.g., a florist) on how to craft the desired customized design that is tied to and based on the user's inputs and selections. According to several embodiments of the invention, the details provided by the user may be converted into informational snippets that can be provided to an order fulfiller as an order notification. It should be understood that the instructions relate to the user's intended recipient, relationship, reason for purchasing the gift product, goal, and other information provided by the user, and convey the snippets incorporating some or all of that information to the florist instead of providing a conventional rigid recipe listing the quantity and type of flowers to include in an arrangement. In this manner, the florist can freely associate the information provided in the informational snippets, match them to flower meanings, and select appropriate types of flowers for the custom arrangement that is reflective of the user's reason, relationship, and goal(s). In alternative embodiments, the generation of the unique recipe or instructions for products in other industries would accordingly detail how to craft and produce the desired customized design for the product of that industry guided by the reasons, emotions, and goals obtained from the information provided by the user.

Thus, in accordance with the preferred embodiments of the invention, the generation of a customized product page in the context of purchasing a customized floral arrangement can depend on the collection of user input pertaining to a variety of factors affecting product (e.g., flower composition) selection. Initially, the relationship of the user (interchangeably referred to herein as the “sender”, as applicable) to the recipient may be collected. Further, in certain circumstances, where appropriate and depending on the particular relationship selected or indicated, the name of the recipient may also be collected from the user. In the preferred embodiments the reason for the floral purchase (e.g., 30th birthday, make them smile, anniversary, just because etc.) may be collected as well. Additionally, the emotional state as well as the emotional goal of the sender or, in other words, how the sender hopes the recipient will feel upon receiving the gift can also be collected. As noted above, in addition to being obtained using questions and prompts represented visually, this information (e.g., factors affecting gift selection including emotional state, emotional goal, etc.) may be obtained through the collection of facial and gesture data via an image capture device as well as via a device configured to capture and/or record sounds as discussed in more detail below. Optionally, in some embodiments, information indicating a preferred “main flower” selected or input by the user may also be obtained. It should be noted that if any of the aforementioned information is missing or otherwise not entered, selected, or provided by the user, the various embodiments of the invention accommodate those circumstances by defaulting to pre-selected default states and choices for the generation of the customized product page. In this manner, a generous amount of flexibility is incorporated for the creation of the product page and, consequently, the customized gift product without necessitating any particular input and/or selections from the user.

Accordingly, based on the collected information, a customized product page is generated with the embodiments of the invention. In the context of a floral purchase, such a customized product page may include a background hero image, a product card, one or more description blocks, an inspiration phrase, and a star flower block.

An example of a background hero image may include an image of a floral workbench showing a floral artist at work and may incorporate flowers and ancillary elements. The generation and depiction of the background image is dynamic and is based on the reason, relationship, and emotional goal obtained from the user as well as on the interpretation thereof. Accordingly, the colors, flower images, and ancillary elements depicted should visually support and correspond to the answers/input provided by the user (e.g., a selection of “Mom's birthday” could show a background image with bright flowers candles and a “happy birthday Mom” card). In embodiments of the present invention, different sets of inputs including those obtained for recipient identity, relationship, reason, emotional goal, etc. may respectively result in a different background being generated and displayed on the customized product page.

An exemplary product card in the same context may include a product name and customization recommendations for the design, color(s), and presentation options. The product name may be dependent on and derived from the name of the recipient, the relationship of the recipient and the sender, and/or the reason for choosing to purchase or send the gift product each respectively obtained from the user or on the interpretation thereof. Accordingly, for every selection of a customized gift product design, a different product name may respectively be presented on the product card. Similarly, the initial recommendations for color palette and design presentation in the context of a floral purchase are also based on the reason for the purchase (and, optionally, other input provided by the user such as the recipient's identity, relationship, emotional goal etc.) These initial recommendations can be changed, and other options can be selected by the user via interactive visual selection means (e.g., drop-down menus, lists, radio buttons, check boxes, hyperlinked tables, and the like) allowing the customized page to cater to the user's individual taste regardless of the default selections generated based on the user's input. It should be understood by one skilled in the art that instances of user selection and input that may occur in the operation of the various embodiments of the invention may be received via a variety of graphical and non-graphical interfaces including voice prompts and automatic selection and that embodiments of the invention are contemplated to be used with any such graphical (i.e., visual) or non-visual user input interfaces.

Analogously, a description block can include a textual description of the customized product that is dynamically dependent on the user's previous input and the information collected. As in the case with the hero background image and the product card, the description in the description block can likewise be derived and based on information such as the reason for purchase, gifting goal, relationship, etc. obtained from the user. It should be understood that the various possible combinations of gifting reasons, relationships, and gifting goals along with any other inputs and selections provided by the user could dynamically result in a different product description being generated and presented on the customized product page.

The inspirational phrase included in the customized product page, in accordance with embodiments of the present invention, can be a comma-separated phrase list that explains the inspiration of the product. Similar to the main description block, the generated inspiration phrase can also be derived from or based on the reason, gifting goal, relationship and other inputs and selections obtained from the user and/or interpretations thereof. Accordingly, the presentation of the inspirational phrase can be in the form of a comma-separated list based on a mapped set of outcomes resulting from the user input.

Further, an optional star flower block may be included in a customized product page that could include an image and a description of the main flower to be used in the customized product (e.g., custom flower arrangement). As in the case of the previously described elements of the customized product page, the “star” or main flower to be featured in the arrangement could be selected directly by the user or indirectly derived as a selection based on a user input. For example, it also may be automatically derived based on the reason for the purchase. This section could be dynamically presented regardless of whether a star flower is chosen/derived or not and could include references to and explanations of why this flower may be appropriate for a given purchase.

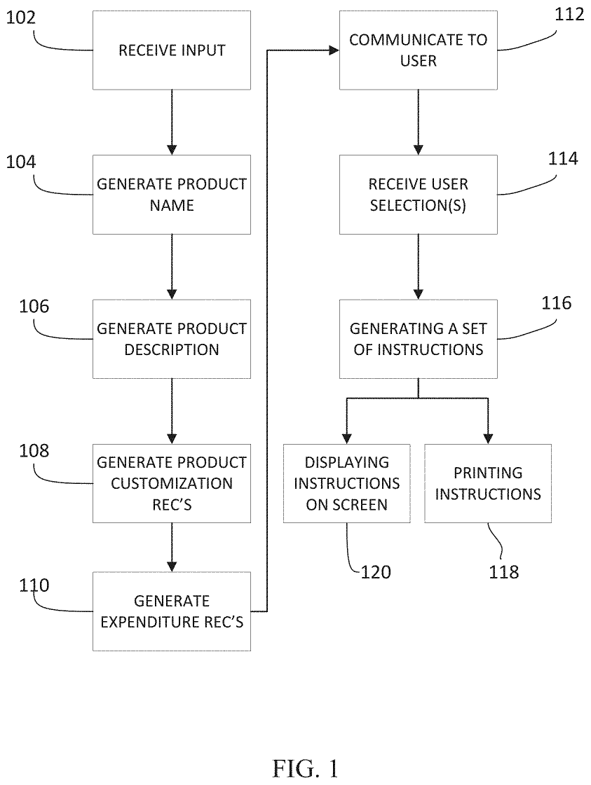

Referring now to the drawings in which like numerals represent the same or similar elements and initially to FIG. 1, an exemplary method of generating a gift product is provided. Initially, plurality of user inputs representative of factors affecting product selection are received 102 and/or collected. These inputs via a product customization system comprising a user interface communicatively coupled to a networked user device including a processor device. For example, a user can input free-text inputs or make selections on a touch screen of a smart phone or via a keyboard and screen of a personal computer, in each case in response to prompts and questions presented by the visual display elements or audio elements of the exemplary system.

Further, embodiments of the present invention can include generating a product name 104, generating a product description 106, and generating a plurality of product customization recommendations 108. As described above the generation of the product name, product description, and product customization recommendations can be dependent on and derived from the previous inputs provided and selections made by the user. Some embodiments can include, generating a plurality of expenditure recommendations 110 to provide the user with options to select how much they may want to spend on a particular customized product option. Next, each of the product name, the product description, the plurality of product customization recommendations, and the plurality of expenditure recommendations are communicated 112 to the user via the user device. It should be noted that the communication 112 is contemplated to take any form perceivable by a user including, textual, audio, visual, and audio-visual representations of the information. For example, the suggestions and options may be communicated to a user seeing choices on a screen of a computing device or communicated by audio to a user through a smart speaker that can register user responses and selections.

Accordingly, some embodiments also include receiving a user selection 114 via a user interface, for each of a color palette, a product customization, and an expenditure amount and thereafter generating a set of instructions 116 for creating the gift product based on the user inputs and user selection. A person of ordinary skill in the art should understand that the generation of a product name, product description and expenditure recommendations as well as the provision and selection of customization options may be different in the context of a purchase of a product of a different industry (i.e., a product other than a floral arrangement). As described earlier, the customizations and configurations of customized clothing gift products of sports sets as well as the descriptions thereof would respective involve different parameters applicable to the relevant industry and products falling in their respective categories (i.e., clothing and sports equipment respectively). It should also be understood that generating each of the product name 104, the product description 106, product customization suggestions 108, and a plurality of expenditure recommendations 110 can respectively depend at least in part on an input of the plurality of inputs 102. In some embodiments, generating a plurality of product customization recommendations 108 can include generating a plurality of product color palette recommendations and can also include generating a plurality of presentation recommendations.

Optionally, embodiments of the invention can include displaying 120 the set of instructions on a screen or printing 118 the set of instructions. In this manner, an order fulfiller can perceive and interact with either a digital or physical copy of the instructions or recipe for creating the customized product, and design the gift product in accordance with the user's intentions. It should be understood by one of ordinary skill in the art that in some embodiments of the invention, the user interface for both the user selections and input as well as for an order fulfiller can be a display coupled to a touch-sensitive input means (e.g., a touchscreen or keyboard). Alternatively, such a user interface of an embodiment of the invention can be an audio device configured to emit sounds and receive voice input (e.g., a smart speaker, smart hub, or smart TV).

The above described methods of the embodiments of the present invention can be performed on a computing device, a set of interlinked computing devices, or embodied as computer readable and/or executable instructions on a non-transitory computer readable medium. It should be understood that the computer readable program instructions may execute entirely on a user's computing device, partly on the user's computing device, as a stand-alone software package, partly on the user's computer and partly on a remote computing device (e.g., a server), or entirely on a remote computing device or server. In the latter scenario, the remote computing device may be connected to the user's computing device through any type of network, including a local area network (LAN) or a wide area network (WAN), or the connection may be made to an external computing device (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

According to an exemplary embodiment of the invention, data may be transferred to the system, stored by the system and/or transferred by the system to users of the system across LANs (e.g., office networks, home networks) or WANs (e.g., the Internet). In accordance with such an embodiment, the system may be comprised of numerous computing devices and/or numerous servers communicatively connected across one or more LANs and/or WANs. For example, there may be a hand-held computing device being operated by a user to send input and selections via the internet to a server to generate the customized product page on the display of the hand-held device. One of ordinary skill in the art would appreciate that there are a variety of ways in which the system could be configured, and embodiments of the invention are contemplated for use with any such configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). For example, a user may be operating a laptop to input the aforementioned information relevant to making a product selection and thereafter having the laptop generate the customized product page along with all of its respective elements described above without needing the laptop to be connected to the internet. Consequently, once the laptop is connected to the internet, the customized instructions can be sent to a device accessible by an order fulfiller such as a florist to enable them to produce the customized gift product in accordance with the user's intentions. Therefore, in some embodiments, some of its applications, features, or functions may not be accessible when not connected to a network, however a user or a module/component of the system itself may be able to compose, combine, or generate data offline from the remainder of the system that will be consumed by the system or its other components when the user/offline system component or module is later connected to the system network.

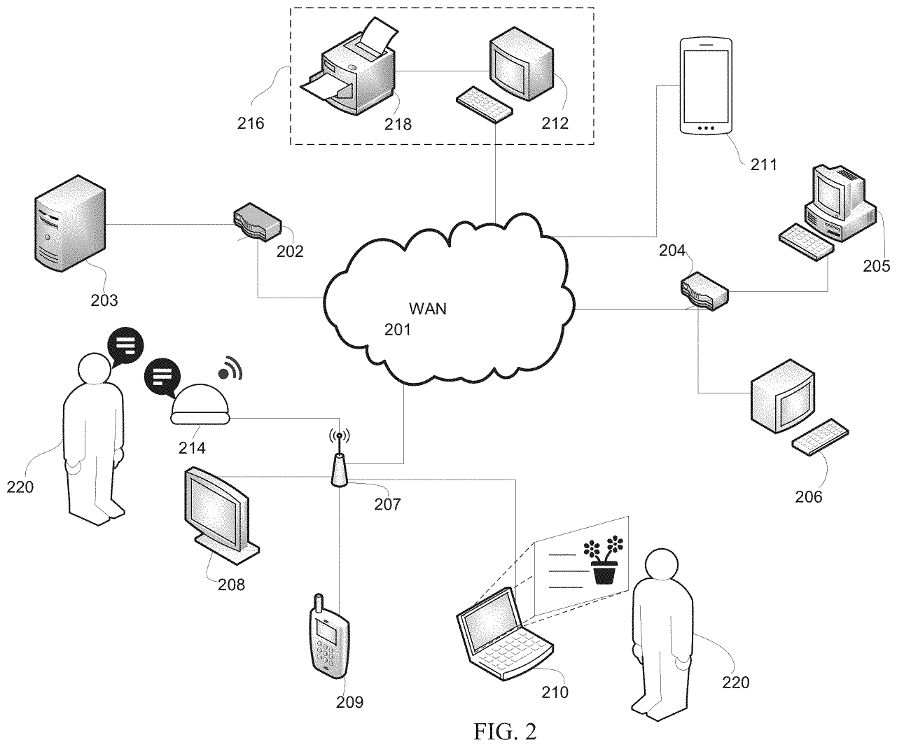

Referring to FIG. 2, a schematic overview of a system in accordance with an embodiment of the invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments of the invention may or may not utilize one or more routers 202. One of ordinary skill in the art would appreciate that there are numerous ways server 203 may connect to WAN 201 for the exchange of information, and various embodiments of the invention are contemplated for use with any method for connecting to networks for the purpose of exchanging information. Further, while this application refers to high speed connections, embodiments of the invention may be utilized with connections of any speed.

Components, elements, or modules of the system may connect to server 203 via WAN 201 or other network in various ways. For instance, a component or module may connect to the system (i) through a computing device 212 directly connected to the WAN 201, (ii) through a computing device 205, 206 connected to the WAN 201 through a routing device 204, (iii) through a computing device 208, 209, 210, 214 connected to a wireless access point 207, or (iv) through a computing device 211 via a wireless connection (e.g., WiFi, CDMA, GMS, 3G, 4G, 5G, other suitable means, and means not yet invented) to the WAN 201. One of ordinary skill in the art will appreciate that there are numerous ways that a component or module may connect to server 203 via WAN 201 or other network, and embodiments of the invention are contemplated for use with any method for connecting to server 203 via WAN 201 or other network. Furthermore, server 203 could be comprised of a personal computing device, such as a smartphone, acting as a host for other computing devices to connect to.

Users 220 of the system in accordance with embodiments of the invention can interact with the system via computing devices such as a laptop 210, personal computers 205, 206, 208, cell phones/smart phones 209, tablets 211, smart speakers 214, smart TVs, smart hubs, smart kiosks, and the like. Each of the abovementioned steps and aspects can be performed via the input and output means of these respective devices including the collection of user input, presentation of options, suggestions, and recommendations, as well as the subsequent collection of user selections and the placement of the order for the customized product. For example, a user 220 can operate a laptop 210 to navigate to a browser interface presenting a web-based version of the invention and be presented with prompts and questions on the screen of the laptop in response to which the user can provide inputs via the keyboard of the laptop.

Consequently, the laptop can generate the product page by processing the user input locally or having it in whole or in part be sent to be processed on a remote device such as a server, to have a customized product page with all of its respective constituent elements be generated on the screen of the laptop. The user can then make selections from among the options presented on the screen and place the order to have the customized “recipe” or instructions for creating the customized product be sent through access point 207 to be displayed or printed on an order fulfiller's (e.g., florist's) device 216 which can include a computer 212 and or a printer 218. Alternatively, upon initializing a smart speaker application version of the invention, user 220 can be prompted with questions and other requests for input via a smart speaker 214. Thereafter, the relevant product name, description, customization and expenditure suggestions can be audibly presented to the user 220 via the smart speaker 214 and permit the user to make selections from among the options and suggestions via voice input. Accordingly, an order can be placed via voice input and the customized “recipe” or instructions for creating the customized product be sent via WAN 201 to be displayed or printed on an order fulfiller's (e.g., florist's) device 216 which can include a computer 212 and or a printer 218.

It should be understood by a person skilled in the art that the aforementioned collection of facial or gesture information can be realized through the use of image capture devices (e.g., camera(s) on a smart phone 209, laptop 210, tablet 211, computer 205 configured with a webcam, smart hubs, smart kiosks etc.) included in a system or device in accordance with an embodiment of the invention. Analogously, the collection of voice information in accordance with the various embodiments can be performed through the use of a microphone or other suitable sound capture and recording device that may be included on a variety of devices such as a smart phone 209, laptop 210, tablet 211, computer 205, a smart speaker 214, and the like.

The communications means of the system, according to embodiments of the present invention, may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, or any combination thereof. One of ordinary skill in the art will appreciate that there are numerous communications means that may be utilized with embodiments of the invention, and embodiments of the invention are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect. It should be understood that a programmable apparatus or computing device can include one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this specification and elsewhere, a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Any combination of one or more computer readable medium(s) may be utilized with the various embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, a static random access memory (SRAM), a digital versatile disk (DVD), a memory stick, a floppy disk, a mechanically encoded device such as punch-cards or raised structures in a groove having instructions recorded thereon, and any suitable combination of the foregoing.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer readable program instructions described herein can be downloaded to respective computing/processing devices from a computer readable storage medium or to an external computing device or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The flowchart and block diagrams in the Figures illustrate the architecture, functionality, and operation of possible implementations of systems, methods, and computer program products according to the various embodiments hereof. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

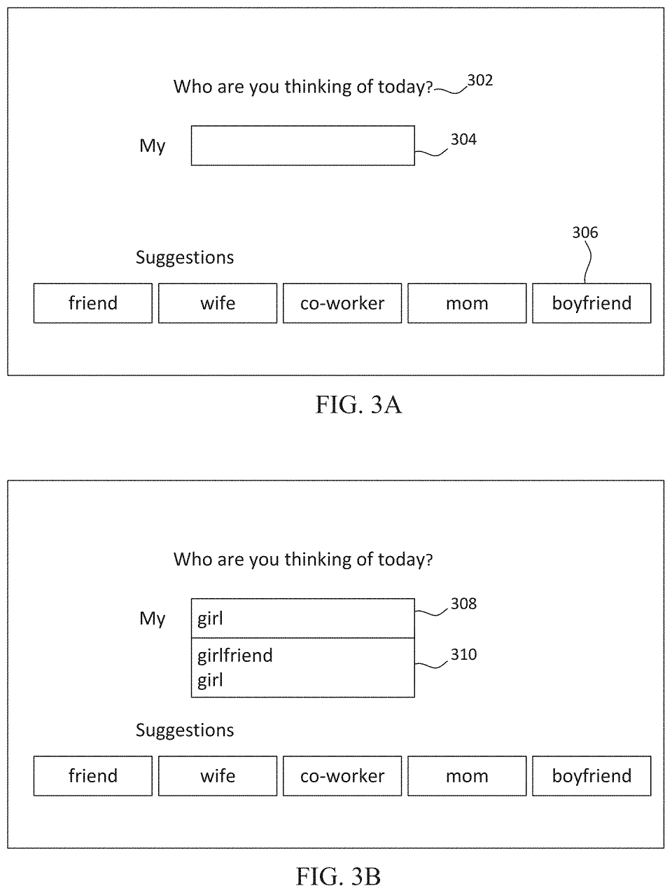

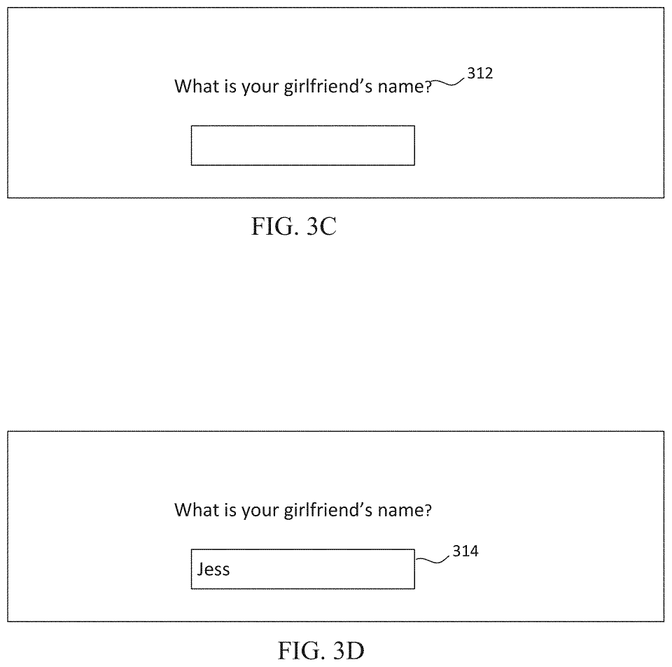

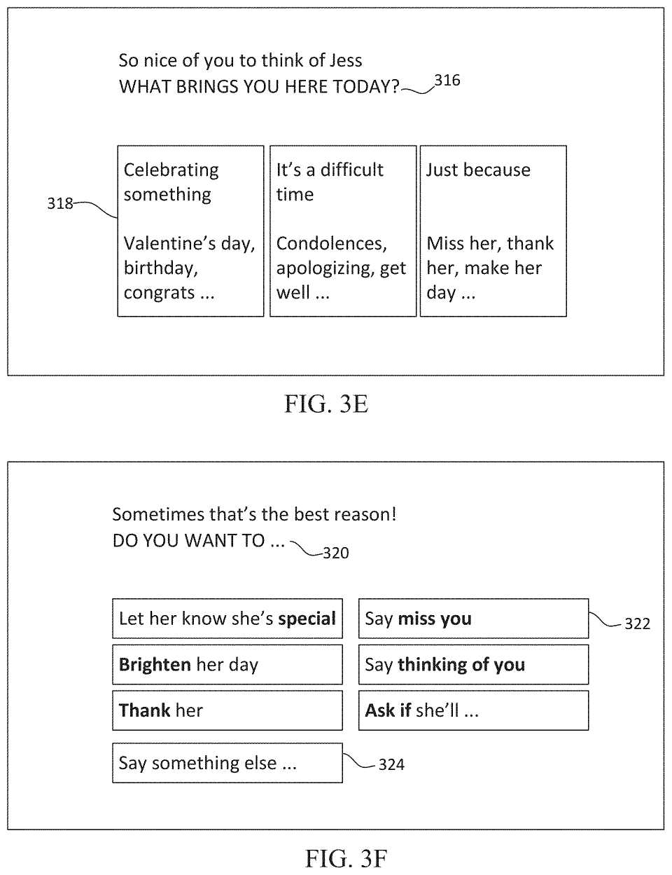

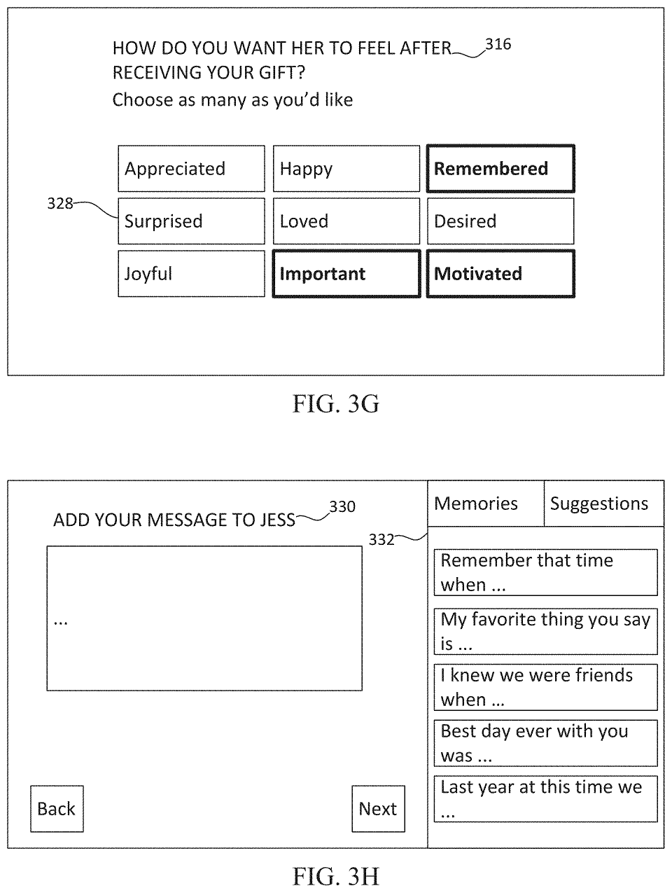

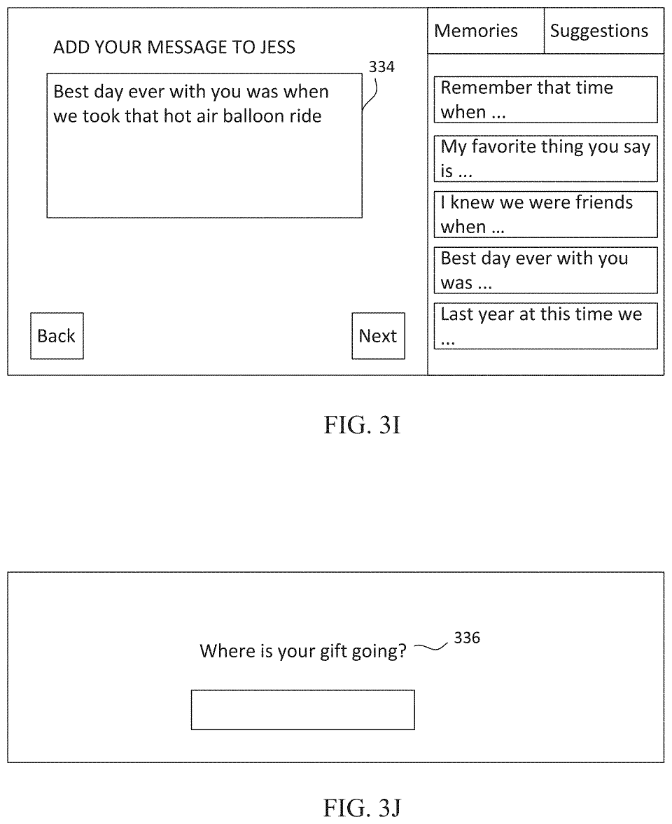

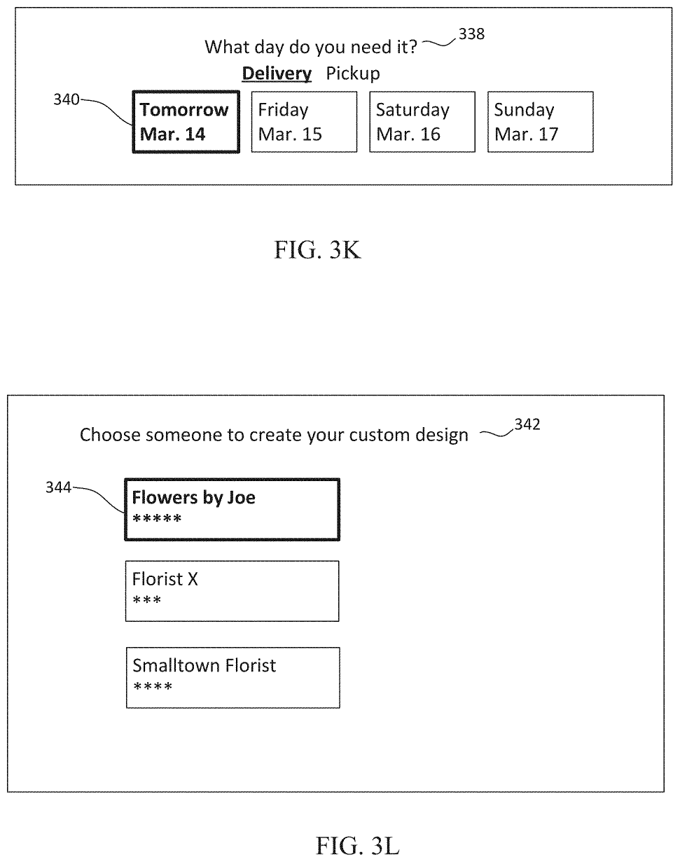

Turning now to FIGS. 3A-3L depictions of various aspects, features, and elements of a web-interface embodiment of the present invention are provided. Primarily, different examples of prompts and questions presented to the user by virtue of which user input is collected are presented in this set of Figures. For example, as can be seen in FIG. 3A, question 302 may prompt the user to indicate the intended recipient of the customized gift product and the relationship of the recipient to the user/sender. The user can then input the response to the questions into input field 304 or select from a variety of suggestions 306 provided below the input field. However, as shown in FIG. 3B, upon beginning to enter a free-text response 308 into field 304, an autocomplete suggestion box 310 may appear below the field 304 which may auto-populate the field 304 upon user selection.

Depending on the user response to the prompt of the previous question, user may be prompted with the screen depicted in FIG. 3C presenting a subsequent question 312, in this case the intended recipient's name, which may be relevant to the selection of the product. Accordingly, as shown in FIG. 3D, a user may input the response (e.g., a name) in the input field 314.

Thereafter, as shown in FIGS. 3E-3G, the user's/sender's reason and emotional goal for purchasing and sending the gift may be identified through the use of questions and prompts. For example, in FIG. 3E, the question 316, may prompt the user to select a reason type from among a set of suggestions 318 which may further expand into the prompt 320 and choices 322 shown in FIG. 3F. Although a variety of choices 322 for identifying the intended reason for the gift purchase are presented, the user may also be able to enter a free-text response in the input field 324. Having provided the reason, the user can then be prompted with a question 326 regarding the emotional state or desired emotion to be conveyed to the recipient as depicted in FIG. 3G and provided with a plurality of emotional options 328 from which to select the desired set of emotions.

Consequently, with reference to FIGS. 3H and 3I, a user may be prompted 330 to add a message to go along with the gift product to be sent to the recipient. As in other instances, the user may be able to enter free-text input or select from a plurality of suggestions 322 including pre-made text to be included in the message field 334.

It should be understood that different selections, inputs, and responses to the interfaces presented in each of FIGS. 3A-3I can result in different subsequent questions, prompts, and input options. Accordingly, each different selection, input, or response at some stage of the process can result not only in a different product page with different recommendation but also result in a different sequence of subsequent questions, prompts, and input options appearing or being presented to the user leading up to the product page described in more detail below. Notably, although each subsequent interface may be dynamic and dependent on a user's previous inputs, selections, or responses, the overall logic and sequential flow of the interfaces can remain the same and be directed towards obtaining a more granular identification of a user's emotional goal or gift-giving intention.

It should be understood that, as depicted in FIGS. 3J-3K, the prompts and questions in accordance with the embodiments of the present invention may collect more conventional information that may be pertinent to order fulfilment and delivery of a product. For example, the user may be prompted with a question 336 regarding the intended destination of the customized gift product as seen in FIG. 3J. FIG. 3K shows an inquiry 338 regarding the delivery date and, on the screen depicted therein, the user may be prompted with a set of options 340 and may be able to choose between delivery or pick-up and from among a plurality of such delivery/pick-up dates. Turning now to FIG. 3L, a user may be presented with a prompt 342 to select the desired order-fulfiller 344, in this case a florist/artist, to create the customized gift product (e.g., customized floral design).

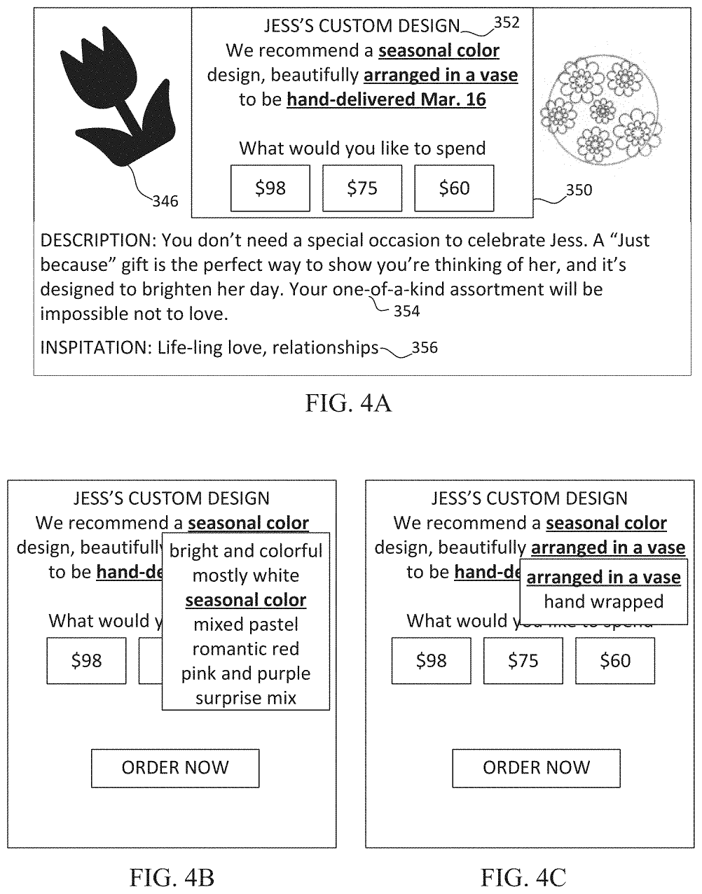

Having provided the various user inputs and made the relevant selections, a user of an embodiment of the instant invention may be presented with the customized product page depicted in FIG. 4A. As explained earlier, the customized product page may include a background hero image 346, a product card 350 (including a product name 352), a product description block 354, and an inspiration phrase 356. As shown in FIGS. 4B and 4C, the product card 350 can include a plurality of product customization suggestions and options including a color palette recommendation 358, a presentation recommendation 362, and a plurality of expenditure/cost options 366. However, a user may be freely able to alter the pre-selected suggestions by selecting from a plurality of color palette options 360 and presentation options 364. With the desired selections being made or confirmed by the user, the user can place the order for the customized gift product by following a conventional process of providing payment information and more specific delivery information. Additionally, in some embodiments of the invention, at any stage of the process a user may be presented with the option of skipping subsequent questions or prompts and be immediately directed to the end of the process presenting the user with a customized product page which can, however, be less customized and less accurately reflective of the user's goals, intentions, and/or emotions. In these embodiments, when the option of skipping or foregoing subsequent prompts and/or questions is selected by the user, default values, inputs, or selections can be chosen for the prompts or questions that were skipped by the user. This option may be used by users for whom the precision of matching the customized gift product design is less important than ordering the gift product more quickly.

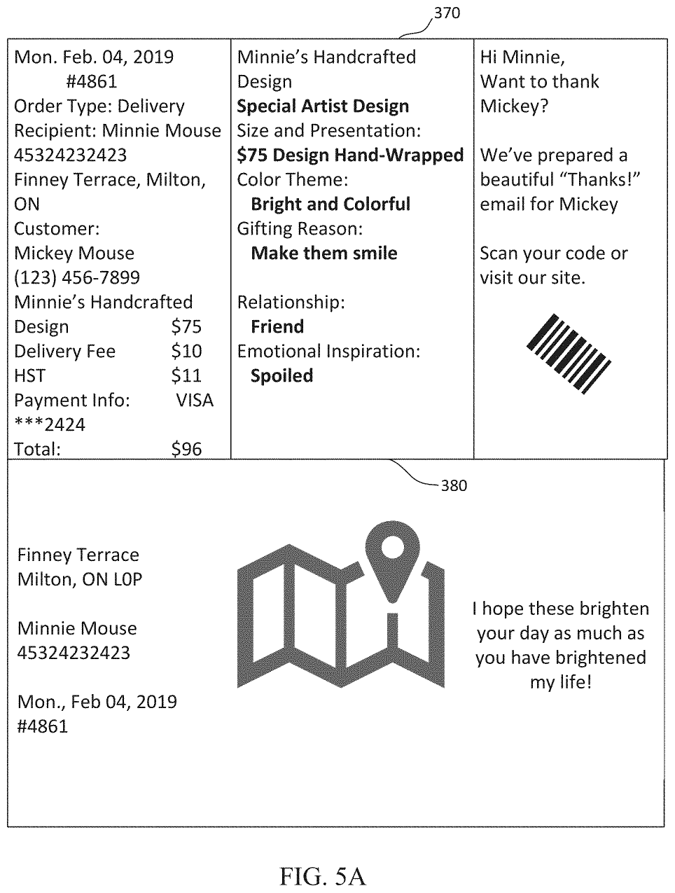

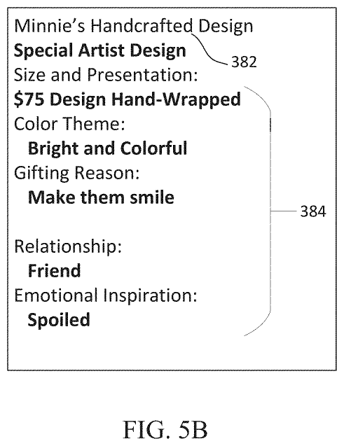

Once the order is placed, in accordance with the various embodiments of the invention, a recipe or a customized set of instructions is generated for the creation of the customized gift product to be then sent to the order fulfiller. In the context of a floral gift purchase, a recipe may be generated and sent from a user device to a florist's device. As shown in FIG. 5A, such a recipe 380 may be included in a super-ticket 370 that can be displayed on a florist's device or printed by the florist. The recipe, shown in more detail in FIG. 5B, can include the product name 382 as well as a plurality of informational snippets 384, all of which are derived from the various inputs and selections previously made by the user. Notably, the recipe is not rigid and does not contain a specific listing of the stem count and types of flowers to be included in the customized arrangement, but instead provides a collection of information or clues that the florist can use to craft a completely custom and unique arrangement based on the user's intent.

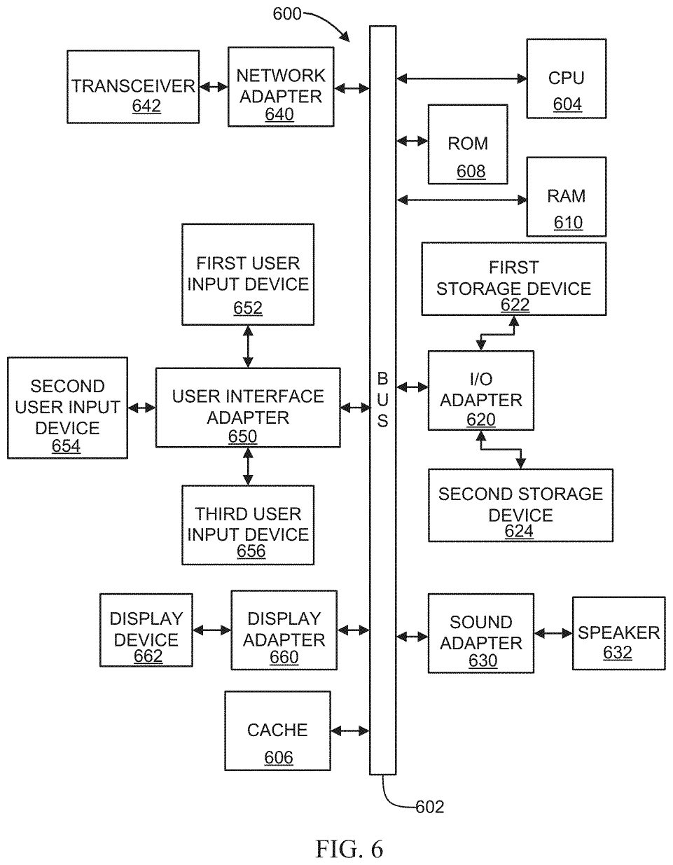

As noted earlier, the methods described above as well as the exemplary web-interface based system may be implemented on a variety of computing devices or. An illustrative representation of an exemplary computing device/processing system in accordance with an embodiment of the present invention is shown in FIG. 6. The computing device 600 can generally be comprised of a Central Processing Unit (CPU) 604 operatively coupled to other components via a system bus 602, optional further processing units including a graphics processing unit (GPU), a cache, a Read Only Memory (ROM) 608, and a Random Access Memory (RAM) 610. The computing device 600 can also include an input/output (I/O) adapter 620, a sound adapter 630, a network adapter 640, a user interface adapter 650, and a display adapter 660, all of which may be operatively coupled to the system bus 602.

Additionally, a first storage device 622 and a second storage device 624 can be operatively coupled to system bus 602 by the I/O adapter 620. The storage devices 622 and 624 can be any of a disk storage device (e.g., a magnetic or optical disk storage device), a solid state magnetic device, and so forth. It should be appreciated that the storage devices 622 and 624 can be the same type of storage device or different types of storage devices. In instances where the device 600 is embodied by a smart speaker 214 or the like, it can incorporate a speaker 632 which may be operatively coupled to system bus 602 by the sound adapter 630. A transceiver 642 may be operatively coupled to system bus 602 by network adapter 640. In instances where the device 600 is embodied by a laptop 210 or a smart phone 211, it can include a display device 662 which may operatively coupled to system bus 602 by display adapter 660.

In some embodiments, the device 600 may include a mother board, alternatively/additionally a different storage medium (e.g., hard disk drive, solid state drive, flash memory, cloud storage), an operating system, one or more application software and one or more input/output devices/means, including one or more communication interfaces (e.g., RS232, Ethernet, Wifi, Bluetooth, USB). Useful examples of applicable devices for use in embodiments of the invention include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

Accordingly, in some embodiments a first user input device 652, a second user input device 654, and a third user input device 656 may be operatively coupled to system bus 602 by user interface adapter 650. The user input devices 652, 654, and 656 can be any of a keyboard, a mouse, a keypad, an image capture device (e.g., a camera), a motion sensing device, a microphone, a touch-sensitive device (e.g., a touch screen or touchpad), a device incorporating the functionality of at least two of the preceding devices, and so forth. Of course, other types of input devices can also be used, while remaining within the scope and spirit of the present invention. The user input devices 652, 654, and 656 can be the same type of user input device or different types of user input devices. The user input devices 652, 654, and 656 may be used to input and output information to and from system 600.

Thus, the prompts and questions discussed above may be presented to the user via the output means of exemplary device 600 in accordance with the embodiments of the present invention. Whether visually via a display device 662, audibly via speaker 632, or through a combination of both, a user can be prompted to respond to questions, enter input, or make selections in accordance with an embodiment of the invention. Accordingly, whether through tactile, audio, or video input through input devices 652, 654, and 656 a user can provide the input and selections to interact with the various elements and aspects of the invention to provide the information used for the creation of the customized gift product.

Of course, the processing system/device 600 may also include other elements (not shown), as readily contemplated by one of skill in the art, as well as omit certain elements. For example, various other input devices and/or output devices can be included in processing system 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 600 are readily contemplated by one of ordinary skill in the art given the teachings of the embodiments provided herein.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

It will be appreciated that computer program instructions may include computer executable code. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including a functional programming language such as python, an object oriented programming language such as SMALLTALK, C++ or the like, and conventional procedural programming languages, such as the “C” programming language or similar programming languages. A variety of languages for expressing computer program instructions are possible, including without limitation, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

As employed herein, the term “hardware processor subsystem”, “hardware processor”, “processing device”, or “computing device” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. Within this field, the configuration and management of large networks include storage devices and computing devices that are communicatively coupled to dissimilar computing and storage devices over a network, such as the Internet, also referred to as “web” or “world wide web”.

Throughout this specification and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the invention are contemplated for use with any language.

Reference in this specification to “one embodiment” or “an embodiment” of the present invention, as well as other variations thereof, means that a particular feature, structure, characteristic, and so forth described in connection with the embodiment is included in at least one embodiment of the invention. Thus, the appearances of the phrase “in one embodiment” or “in an embodiment”, as well any other variations, appearing in various places throughout the specification are not necessarily all referring to the same embodiment.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims.

1. A computer implemented method for generating a gift product, comprising:
receiving, via a product customization system comprising a user interface communicatively coupled to a networked user device comprising a processor device, a plurality of user inputs representative of factors affecting product selection;
generating a product name;
generating a product description;
generating at least one product customization recommendation;
generating at least one expenditure recommendation;
communicating, via the user device, each of the product name, the product description, the at least one product customization recommendation, and at least one expenditure recommendation to the user;
receiving a user selection, via the user interface, for each of a product customization and an expenditure amount; and
generating, based on the user inputs and user selection, a set of instructions for creating the gift product.

2. The method of claim 1, wherein generating the product name depends at least in part on an input of the plurality of inputs.

3. The method of claim 1, wherein generating the product description depends at least in part on an input of the plurality of inputs.

4. The method of claim 1, wherein generating the at least one product customization recommendation comprises generating at least one product color palette recommendation.

5. The method of claim 1, wherein generating the at least one product customization recommendation comprises generating at least one presentation recommendation.

6. The method of claim 1, wherein generating the at least one product customization recommendation and generating the at least one expenditure recommendation each respectfully depends at least in part on an input of the plurality of inputs.

7. The method of claim 1, further comprising displaying the set of instructions on a screen or printing the set of instructions.

8. The method of claim 1, wherein the user interface is a display coupled to a touch sensitive input means.

9. The method of claim 1, wherein the user interface is an audio device configured to emit sounds and receive voice input.

10. A non-transitory computer readable medium embodying instructions executable by a computing device which when executed cause the computing device to:
prompt a user to input a plurality of user inputs representative of factors affecting product selection into a first user interface of the computing device;
generate a product name;
generate a product description;
generate at least one product customization recommendation;
generate at least one expenditure recommendation;
communicate, via the first interface of the computing device or a second user interface of the computing device, each of the product name, the product description, the at least one product customization recommendation, and the at least one expenditure recommendation to the user;
record a user selection for each of a product customization and an expenditure amount; and
generate, based on the user inputs and user selection, a set of instructions for creating the gift product.

11. The non-transitory computer readable medium of claim 10, wherein the at least one product customization recommendation comprises at least one product color palette recommendation.

12. The non-transitory computer readable medium of claim 10, wherein the at least one product customization recommendation comprises at least one presentation recommendation.

13. The non-transitory computer readable medium of claim 10, wherein the set of instructions is a visually representable set of natural language instructions configured to be printed or displayed on a screen.

14. The non-transitory computer readable medium of claim 10, wherein the first user interface is a display coupled to a touch sensitive input means.

15. The non-transitory computer readable medium of claim 10, wherein the first user interface is an audio device configured to emit sounds and receive voice input.

16. The non-transitory computer readable medium of claim 10, wherein the second user interface is selected from the group consisting of a display coupled to a touch sensitive input means and an audio device configured to emit sounds and receive voice input.

17. A gift product customization system, comprising:
a first computing device connected to a network, the first computing device comprising:
a first user interface configured to convey a series of questions or prompts to a user;
a second user interface configured to receive user input responsive to the series of questions or prompts;
a processor device configured to use the user input to generate a product name, a product description, at least one product color palette recommendation, at least one presentation recommendation, and at least one expenditure recommendation; the first computing device further configured to communicate each of the product name, the product description, the at least one product color palette recommendation, the at least one presentation recommendation, and the at least one expenditure recommendation to a user; and
a second computing device connected to the network configured to communicate a set of instructions for creating the gift product based on user selections among each of the recommendations.

18. The system of claim 17, wherein the first user interface is selected from the group consisting of a display coupled to a touch sensitive input means and an audio device configured to emit sounds and receive voice input.

19. The system of claim 17, wherein the second user interface is selected from the group consisting of a display coupled to a touch sensitive input means and an audio device configured to emit sounds and receive voice input.

20. The system of claim 17, wherein the second computing device comprises at least one of a screen configured to display the set of instruction and a printer configured to print the set of instructions.
